(19) United States
(12) Patent Application Publication
(10) Pub. No.: US 2006/0231702 A1
(43) Pub. Date: Oct. 19, 2006

(54) Furniture Glide

(75) Inventor: Albert E. Straus, Timonium, MD (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(73) Assignee: ACP, LLC, Alabaster, AL (US)

(21) Appl. No.: 10/905,944

(22) Filed: Apr. 5, 2005

(51) Int. Cl. F16M 11/20

(52) U.S. Cl. 248/188.9

(57) ABSTRACT

A furniture glide is mountable on the foot of a furniture leg. The glide is constructed around a glide base having an inner portion and foot support surface. A plurality of spring fingers positioned on the glide base have attached and distal ends. The distal ends extend in an inward direction toward the inner portion of the glide base. The distal ends also extend in an outward direction away from the foot support surface. The positioning of heads at about the distal end of each spring finger allows the spring fingers to receive an outward expansion force when the foot is moved toward the foot support surface. The spring fingers are positioned to move in an inward direction toward the inner portion of the glide base to lock the foot to the furniture glide when the foot contacts the foot support surface.

### BACKGROUND

Feet are frequently positioned on the bottoms of furniture legs to provide improved stability and support, reinforcement, wear reduction or for other purposes where the major structural material of the furniture leg is not the preferred material for providing contact with a surrounding floor. A foot is typically attached to bottom end of a furniture leg so that a contact surface of the foot will contact the floor, the contact surface exerting the load of the leg against the area of floor it contacts. The contact surface preferably comprises a material that minimizes wear and damage to the leg or surrounding floor and may have optional properties that provide transportability, enhanced stabilization, noise and/or friction reduction, or other desirable characteristics.

However, no single foot or single type of contact surface material can be optimally suited for providing all desired properties and characteristics for use with all floor types and floor materials. For example, it may be desirable to use a a piece of furniture in a room having a floor type that is different from the type that the feet of the furniture piece were originally designed for. Feet can also lose some of their desired characteristics after extended use. For example, contact surface material may become worn or damaged and a foot can itself become slightly bent or deformed to an extent that the foot loses some or all of its original desirable characteristics. In some cases, feet may be constructed specifically for purposes such as stability or leg protection, and may lack a suitable contact surface altogether. It may also be desirable to preserve the furniture piece's original feet and contact material from damage or wear due for other reasons, such as for aesthetic or value preservation.

### SUMMARY

The invention includes a furniture glide that can be mounted on the foot of a furniture leg. The furniture glide is constructed around a glide base having an inner portion and foot support surface. A plurality of spring fingers positioned on the glide base have attached and distal ends, with the attached end of each spring finger being connected to the glide base. The distal ends extend in an inward direction toward the inner portion of the glide base. The distal ends also extend in an outward direction away from the foot support surface.

A head is positioned at about the distal end of each spring finger. The positioning of each head allows the heads and spring fingers to receive an outward expansion force from the foot when the foot is moved toward the foot support surface of the glide base. The outward expansion force against the spring fingers is in a direction that is away from the inner portion of the glide base.

The spring fingers are positioned to move in an inward direction toward the inner portion of the glide base when the foot contacts the foot support surface of the glide base. The movement of the spring fingers in the inward direction engages and locks the foot to the furniture glide. Movement of the spring fingers toward the inner portion of the glide base may be effected by the bias of the flexible memory shape of the spring fingers or mechanical actuation such as a spring, by contact or weight actuation such as contact of the foot against the foot support surface, or by other appropriate methods of actuation. In some embodiments, shear forces between the foot and foot support surface provide for additional engagement forces between the foot and furniture glide, especially when the furniture glide is moved across a floor.

Those skilled in the art will realize that this invention is capable of embodiments that are different from those shown and that details of the structure of the disclosed furniture glide can be changed in various manners without departing from the scope of this invention. Accordingly, the drawings and descriptions are to be regarded as including such equivalent furniture glides as do not depart from the spirit and scope of the invention.

### BRIEF DESCRIPTION OF THE DRAWINGS

For a more complete understanding and appreciation of this invention, and many of its advantages, reference will be made to the following detailed description taken in conjunction with the accompanying drawings.

FIG. 1A is a perspective view of a furniture glide of the invention;

FIG. 1B is a top view of the furniture glide of FIG. 1;

FIG. 5C is a side, cross sectional view of the furniture glide of FIG. 1, taken along line 1C-1C of FIG. 1B;

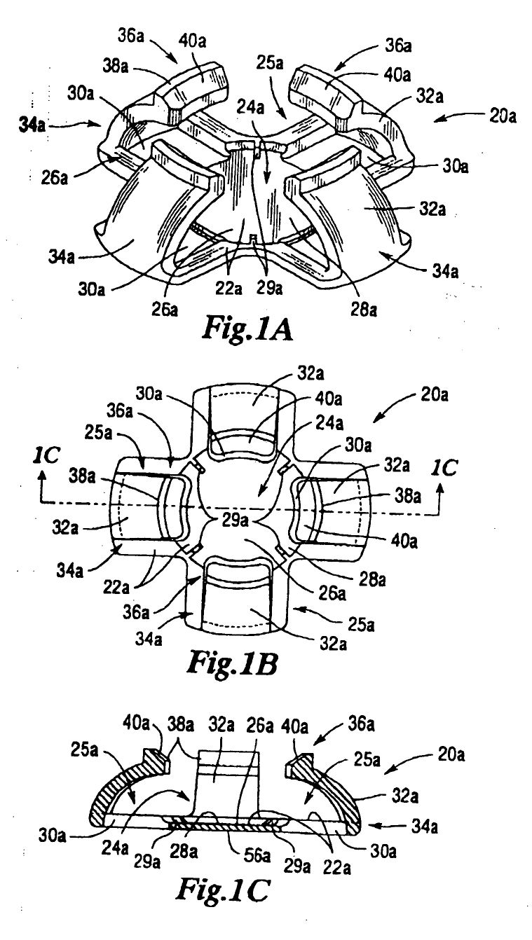

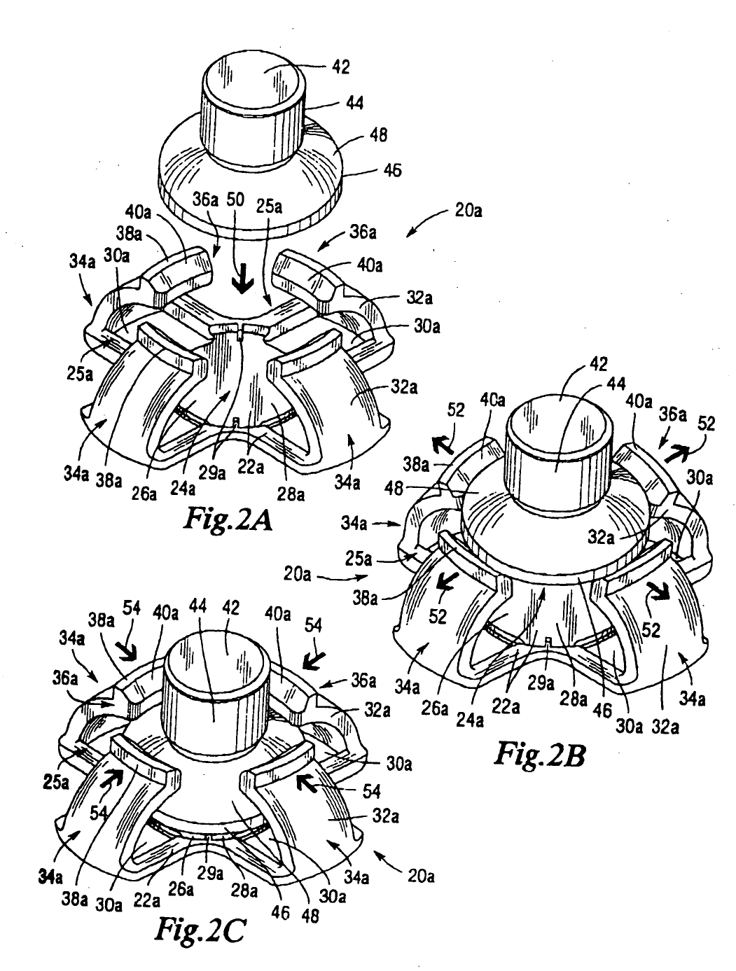

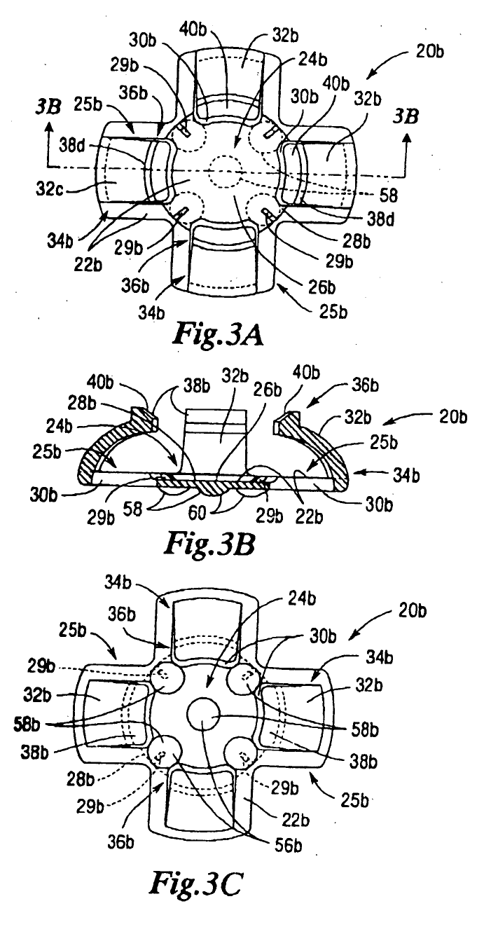

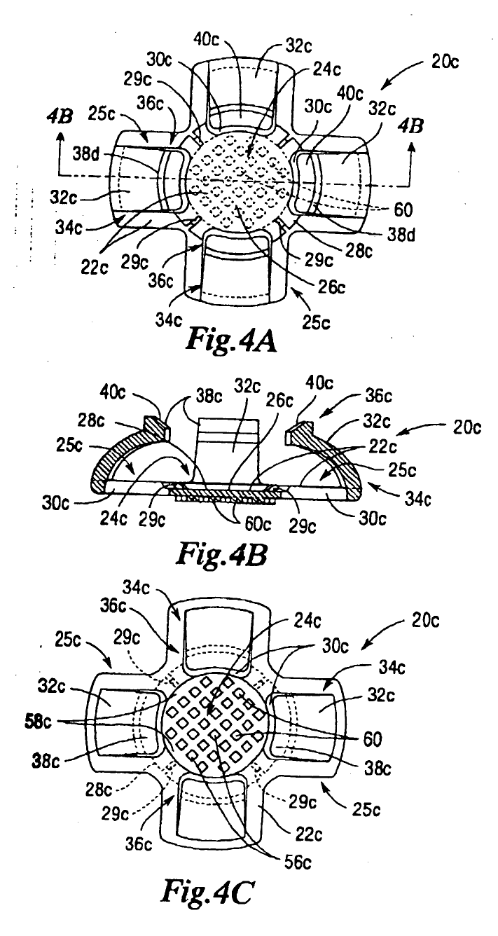

FIG. 2A is a perspective view of the furniture glide of FIG. 1 with a foot shown prior to engagement by the furniture glide;

FIG. 2B is a perspective view of the furniture glide of FIG. 1 with a foot being moved toward the foot support surface of the furniture glide;

FIG. 2C is a perspective view of the furniture glide of FIG. 1 after a foot has been engaged and locked by the furniture glide;

FIG. 3A is a top view of a furniture glide of the invention;

FIG. 3B is a side, cross sectional view of the furniture glide of FIG. 3A, taken along line 3B-3B of FIG. 3A;

FIG. 3C is a bottom view of the furniture glide of FIG. 3A;

FIG. 4A is a top view of a furniture glide of the invention;

FIG. 4B is a side, cross sectional view of the furniture glide of FIG. 4A, taken along line 4B-4B of FIG. 4A;

FIG. 4C is a bottom view of the furniture glide of FIG. 4A;

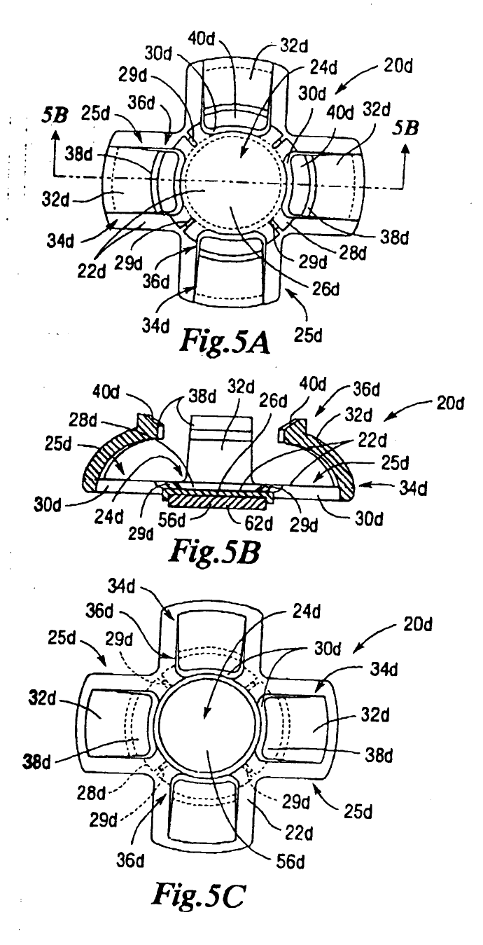

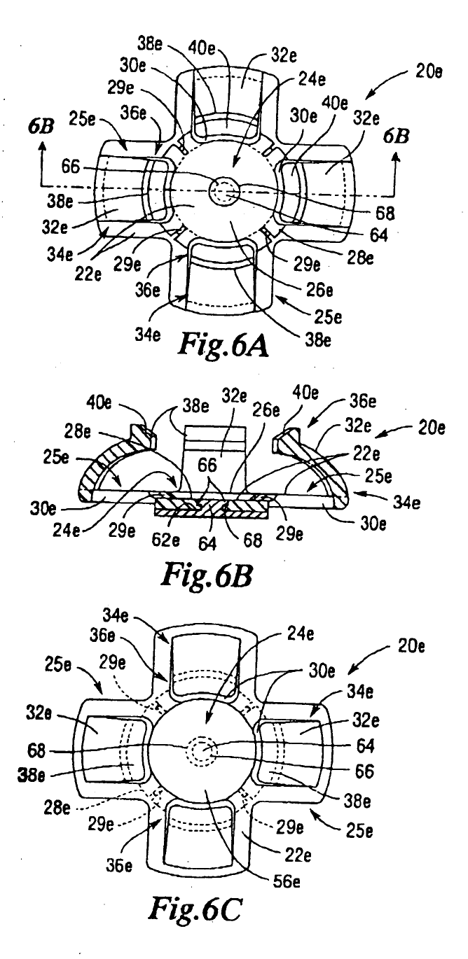

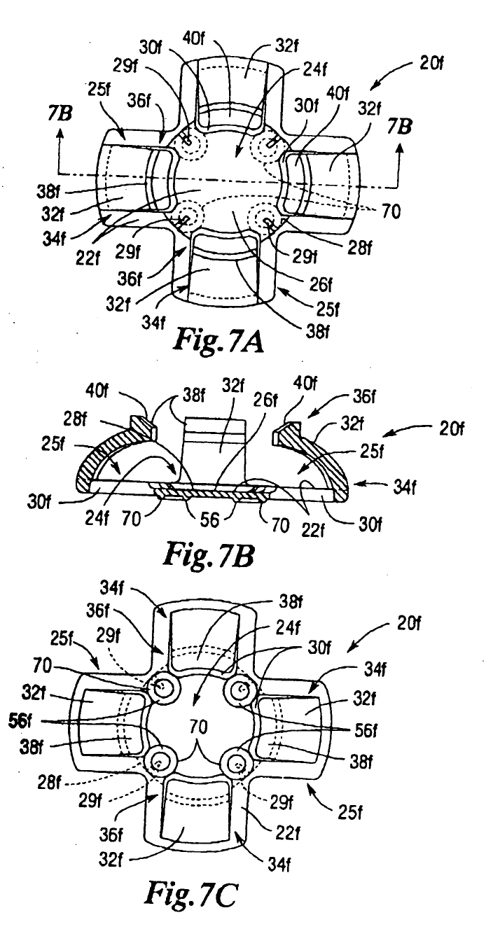

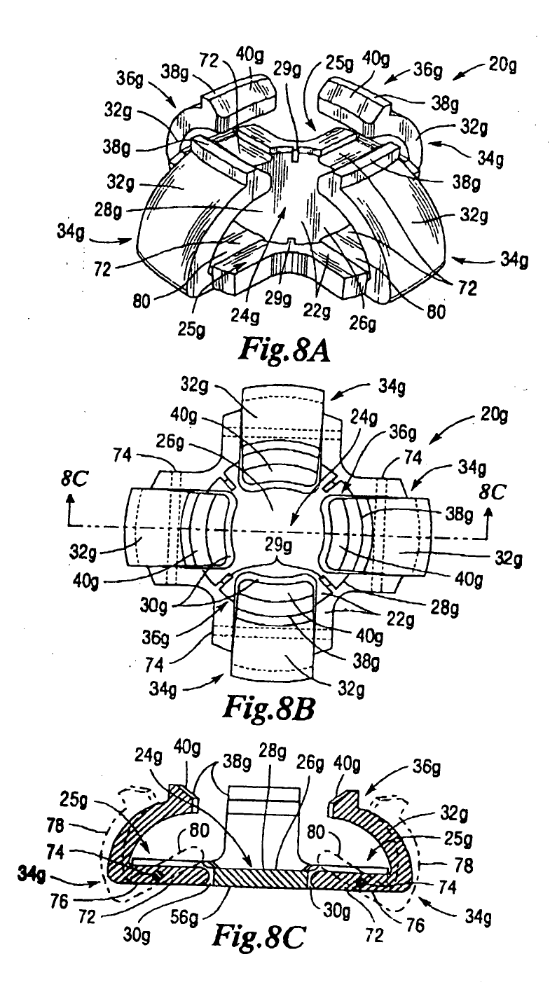

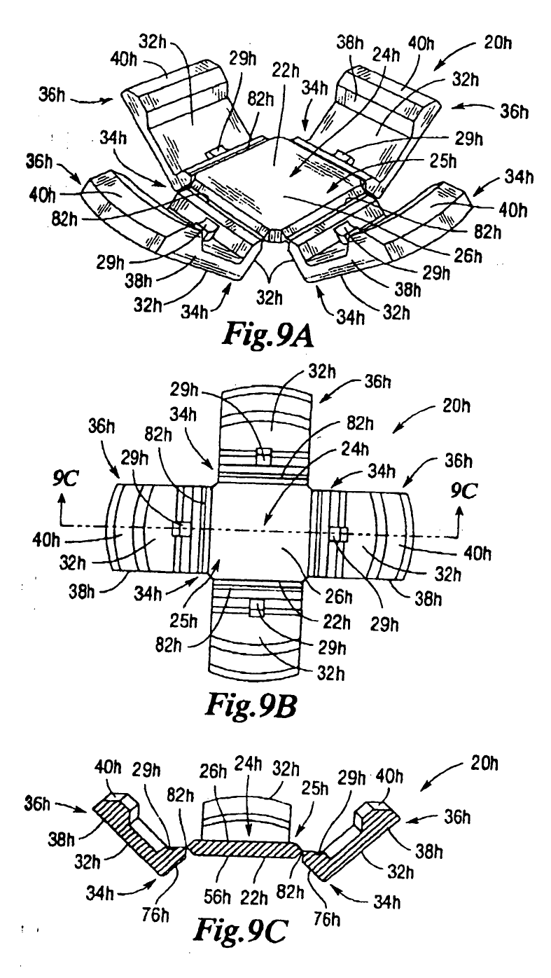

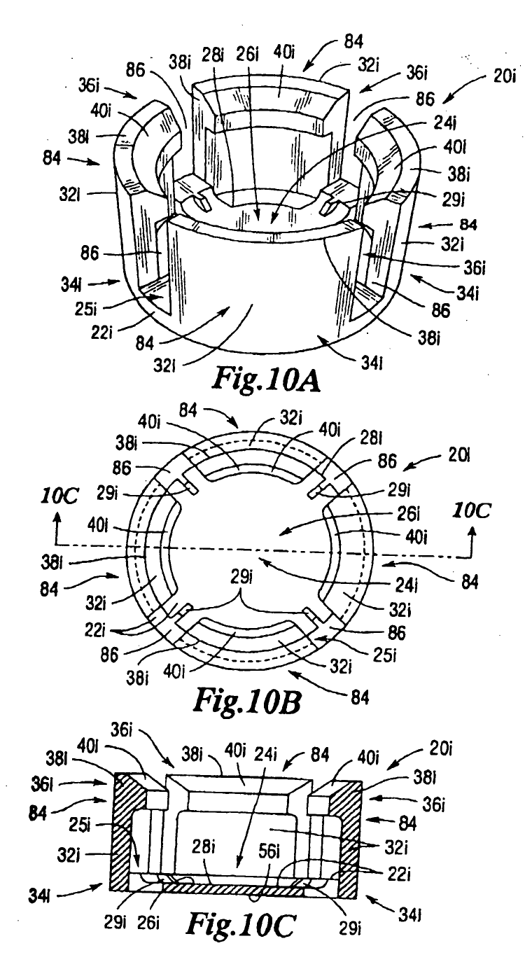

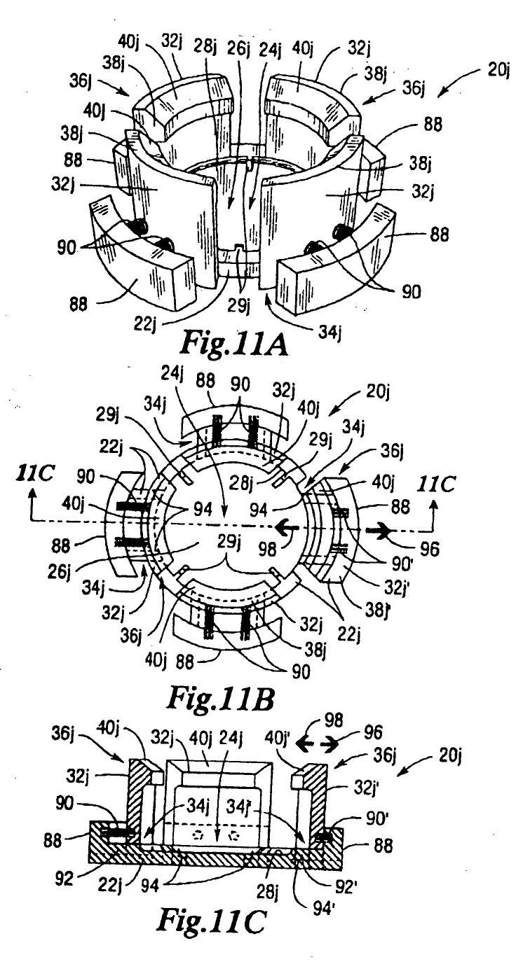

FIG. 5A is a top view of a furniture glide of the invention;

FIG. 5B is a side, cross sectional view of the furniture glide of FIG. 5A, taken along line 5B-5B of FIG. 5A;

FIG. 5C is a bottom view of the furniture glide of FIG. 5A;

FIG. 6A is a top view of a furniture glide of the invention;

FIG. 6B is a side, cross sectional view of the furniture glide of FIG. 6A, taken along line 6B-6B of FIG. 6A;

FIG. 6C is a bottom view of the furniture glide of FIG. 6A;

FIG. 7A is a top view of a furniture glide of the invention;

FIG. 7B is a side, cross sectional view of the furniture glide of FIG. 7A, taken along line 7B-7B of FIG. 7A;

FIG. 7C is a bottom view of the furniture glide of FIG. 7A;

FIG. 8A is a perspective view of a furniture glide of the invention;

FIG. 8B is a top view of the furniture glide of FIG. 8A;

FIG. 8C is a side, cross sectional view of the furniture glide of FIG. 8A, taken along line 8C-8C of FIG. 8B;

FIG. 9A is a perspective view of a furniture glide of the invention;

FIG. 9B is a top view of the furniture glide of FIG. 9A;

FIG. 9C is a side, cross sectional view of the furniture glide of FIG. 9A, taken along line 9C-9C of FIG. 9B;

FIG. 10A is a perspective view of a furniture glide of the invention;

FIG. 10B is a top view of the furniture glide of FIG. 10A;

FIG. 10C is a side, cross sectional view of the furniture glide of FIG. 10A, taken along line 10C-10C of FIG. 10B;

FIG. 11A is a perspective view of a furniture glide of the invention;

FIG. 11B is a top view of the furniture glide of FIG. 11A; and

FIG. 11C is a side, cross sectional view of the furniture glide of FIG. 11A, taken along line 11C-11C of FIG. 11B.

### DETAILED DESCRIPTION

Referring to the drawings, similar reference numerals are used to designate the same or corresponding parts throughout the several embodiments and figures. Specific embodiment variations in corresponding parts are denoted with the addition of lower case letters and/or prime indicators to reference numerals.

FIG. 1A is a perspective view of a furniture glide 20a of the invention. FIG. 1B depicts a top view and FIG. 5C depicts a side cross sectional view of the furniture glide 20a of FIG. 1, along cross sectional line 1C-1C of FIG. 1B. A glide base 22a of the furniture glide 20a includes an inner portion 24a, an outer portion 25a, and a foot support surface 26a. The foot support surface 26a includes an indentation 28a at about the inner portion 24a, the indentation 28a typically shaped to accommodate a foot (not shown in FIGS. 1A-C). Services 29a positioned along the perimeter of the indentation 28a allow for slight variations in the sizes of different feet that may be accommodated by the indentation 28a.

The outer portion 25a of the glide base 22a includes cutaway slots 30a which allow for reductions in weight and the amount of material required for manufacturing the furniture glide 20a without significantly reducing its strength, durability and utility. If the furniture glide 20a is constructed of a polymer material such as plastic, the cutaway slots 30a can also facilitate the design and operation of plastic injection tooling used in the manufacturing of the furniture glide 20a.

Four spring fingers 32a are located about equidistantly from each other in 90-degree increments on the outer portion 25a of the glide base 22a. Each spring finger 32a includes an attached end 34a that is connected to the glide base 22a. Each spring finger 32a also includes a distal end 36a that extends in an inward direction toward the inner portion 24a of the glide base 22a and that also extends in an outward, arcuate direction away from the foot support surface 26a. A head 38a is positioned at the distal end 36a of each spring finger 32a and includes an angled surface 40a for contacting the foot and receiving an expansion force as the foot is moved toward the foot support surface 26a. Each spring finger 32a is molded or formed to the glide base 22a of the furniture glide 20a so that the furniture glide 20a generally comprises a single, flexible furniture glide assembly. The material of the furniture glide 20a will also generally be of a flexible material having a memory shape, the memory shape causing each of the spring fingers 32a to be biased to a position (as shown in FIGS. 1A-B) that allows for the engagement and locking of the foot to the furniture glide 20a when the foot contacts the foot support surface 26a.

Engagement of a foot by the furniture glide 20a can best be understood with reference to FIGS. 2A-C, which together depict the furniture glide 20a of FIGS. 1A-C as a foot 42 is moved toward and contacts the foot support surface 26a. As best understood with reference to FIG. 2A, the foot 42 includes a connector 44, an expanded portion 46, and an upper expanded surface 48. To attach the furniture glide 20a to the foot 42, the foot 42 is moved in a downward direction 50, the expanded portion 46 of the foot 42 being oriented toward the angled surfaces 40a of each head 38a of the spring fingers 32a. The clearance between each of the heads 38a is smaller than the expanded portion 46 of the foot 42, causing the foot 42 to contact at least one or more of the heads 38 as the foot 42 is moved toward the foot support surface 26a. FIG. 2B depicts the foot 42 as the expanded portion 46 contacts the angled surfaces 40a of each head 38a, each spring finger 32a receiving an expansion force in outward direction 52 away from the inner portion 24a of the glide base 22a as the foot 42 continues to move toward the foot support surface 26a. The outward directions 52 of the outward expansion forces are against the bias of the spring fingers 32a created by the memory of the spring fingers, the memory shape being depicted in the view of the furniture glide 20a depicted in FIG. 2A.

Referring now to FIG. 2C, as the foot 42 continues to move toward and contact the foot support surface 26a, the expanded portion 46 passes and clears the inwardly extending distal ends 36a of the spring fingers 32a so that the upper expanded surface 48 of the expanded portion 46 of the foot 42 is beneath the heads 38a and distal ends 36a of the spring fingers 32a. Due to the memory shape of the spring fingers 32a, the spring fingers 32a move in inward directions 54 toward the inner portion 24a of the glide base 22a. This places the heads 38a and distal ends 36a of the spring fingers 32a over the upper expanded surface 48 of the foot's expanded portion 46, resulting in the engagement and locking the foot 42 to the furniture glide 20a as the foot 42 contacts the foot support surface 26a. If the foot 42 also bears the partial or full load of a furniture piece and/or items or occupants thereon, the additional load will be exerted against the foot support surface 26a, which can have the effect of further forcing the spring fingers 32a toward the inner portion 24a of the glide base 22a, further locking the foot 42 to the furniture glide 20a.

As best understood by comparing FIGS. 1A-C with FIGS. 2A-C, the foot support surface 26a is generally shaped to accommodate the foot 42, and may entirely accommodate the foot 42 within the indentation 28a. This partial or full accommodation of the foot 42 contributes to the exertion of shear forces by the glide base 22a against the foot 42 when a furniture leg (not shown) attached to the foot 42 is loaded with the full or partial weight of a piece of furniture and dragged across a floor, reducing laterally-exerted forces against one or more individual spring fingers 32a and providing for additional engagement forces between the foot and glide clip. In some embodiments, a high-friction material may be added to an indentation or another portion of a foot support surface to further increase shear forces of a foot against the foot support surface.

Furniture glides of the invention will typically comprise a material that is suitable for contacting a surrounding floor. The selection of such materials will typically partially depend on whether it is desirable for a piece of furniture having furniture glides to be movable or stationary. If the selected material of the furniture glide is not sufficiently suited for contacting the surrounding floor, another material may be added to the furniture glide. For example, referring briefly to FIG. 5C, a low-friction floor contact surface 56a is added to the glide base 22a of the furniture glide 20a to contact a surrounding floor and to reduce frictional resistance when the furniture glide 20a is dragged across the floor while bearing the load of a piece of furniture. The floor contact surface 56a will, depending on the floor type with which it is intended to be used, typically be of a friction-resistant material such as plastic, Teflon, polymer composite, or other suitable material. If the selected material of the furniture glide 20a is itself suitable for producing low resistance against a particular surrounding floor type, the floor contact surface 56a may also be comprise a segment of the material structure of the glide base 22a. The floor contact surface 56a may also typically comprise a material such as felt, rubber, or soft plastic that will minimize damage to the surrounding floor type when the attached piece of furniture is dragged or used in a stationary location. The material of the floor contact surface 56a may also be chosen for its ability to minimize noise when the furniture glide 20a is dragged while under load.

Although the invention has been shown and described as having a floor contact surface that is suited for minimizing frictional resistance against a surrounding floor, it will be appreciated that some embodiments of the invention may incorporate a high-friction producing material where it is desirable for a piece of furniture to be stationary, more stable, or not easily movable across a surrounding floor. For example, the floor contact surface 56a depicted in FIG. 5C could be substituted with a high friction-producing material to prevent movement of an attached furniture piece. Such suitable materials could include rubber, velcro, selected polymer composites, and other materials having relatively high coefficients of friction. The use of such high-friction producing materials is contemplated to be within the intended scope of the invention.

It will be further appreciated that different structural arrangements can also be used to provide contact between a furniture glide of the invention and a surrounding floor. For example, FIG. 3A is a top view of a furniture glide 20b of the invention having multiple floor contact blisters 58 located on the glide base 22b below the indentation 28b. FIG. 3B depicts a side cross sectional view of the furniture glide 20b along line 3B-3B of FIG. 3A. A bottom view of the furniture glide 20b is depicted in FIG. 3C.

As best understood by comparing FIG. 3B to FIGS. 3A and 3C, the blisters 58 are smooth and rounded in shape so that a relatively small surface area of each blister 58 actually makes contact with a floor. The smooth shape of the blisters 58 combined with the combined, reduced surface area of the furniture glide 20b that contacts the floor substantially reduces friction to enable a piece of furniture to be easily moved when the furniture glide 20b is moved across a floor. The blisters 58 will also typically comprise a material that will minimize damage to the floor and/or minimize noise that results when the furniture glide 20b is moved across the floor. The blisters 58 can be part of the single, integral assembly of the furniture glide 20b or be part of a floor contact element that is attached to the glide base 22b with either a structural or adhesive connection.

FIG. 4A is a top view of a furniture glide 20c of the invention having a floor contact surface 56c that is dimpled below the indentation 28c. FIG. 4B depicts a side cross sectional view of the furniture glide 20c along line 4B-4B of FIG. 4A. A bottom view of the furniture glide 20c is depicted in FIG. 4C. The dimples 60 reduce the amount of surface area of the floor contact surface 56c that makes contact with a floor, substantially reducing friction to enable a piece of furniture to be easily moved when the furniture glide 20b is moved across the floor. The dimpled floor contact surface 56c can also be part of the single, integral assembly of the furniture glide 20c or be part of a floor contact element that is attached to the glide base 22c with either a structural or adhesive connection.

FIGS. 5A-C depict an example of such an adhesive connection between a glide base 22d and a floor contact surface 56d. As best understood by comparing the top and bottom views of FIGS. 5A and 5C with the side cross sectional view of FIG. 5B, The floor contact surface 56d is bonded to the glide base 22d below the indentation 28d and against an adhesion surface 62d. The bond between the floor contact surface 56d and adhesion surface may be created with an epoxy, glue, or other appropriate adhesive that is suited for the material of the floor contact surface 56d. Such an adhesive or bonded connection between the floor contact surface 56d and glide base 22d may be optimal where the floor contact surface 56d is intended to minimize noise and damage when the furniture glide 20d is dragged across a floor. For example, bonded felt may be used as the floor contact surface 56d where a piece of furniture is to be positioned on or dragged across a hard, uncarpeted floor to reduce friction while the furniture glide 20d engages a foot (not shown in FIGS. 5A-C). In such an application, it may be undesirable to have contact surface attachment hardware, such as screws or rivets, positioned where the hardware could be exposed to contact the floor.

A floor contact surface can also be attached to a furniture glide of the invention mechanically or by a combination of mechanical and adhesive or bonded attachments. For example, FIGS. 6A-C depict a furniture glide 20e having a button connector 64 which is an structural extension from the floor contact surface 56e that extends through the glide base 22e and locks the floor contact surface 56e to the foot support surface 26e with an expanded button portion 66. A best understood by comparing the side cross sectional view of FIG. 6B with the top and bottom views of FIGS. 6A and 6B, the expanded button portion 66 fits within a button recess 68 so that the top of the expanded button portion 66 remains flush with the indentation 28e of the foot support surface 26e, enabling the floor contact surface 56e to be securely fastened to the furniture glide 20e without interfering with the engagement of a foot (not shown in FIGS. 6A-C) or the bearing of the foot's load. Optionally, the addition of an adhesive to an adhesive surface 63e can further secure the foot support surface 26e to the furniture glide 20e.

Although the invention has been shown and described with a button connector, it will be appreciated that other types of mechanical connections are also possible and are within the intended scope of the invention. Other such types of mechanical connections include undercuts, dovetail connections, connections using hardware such as screws, rivets, and foots, and other appropriately implemented types of connectors.

Referring now to FIGS. 7A-C, a furniture glide 20f of the invention includes multiple donut dimples 70 located on the glide base 22f below the indentation 28f. FIG. 7B depicts a side cross sectional view of the furniture glide 20f along line 7B-7B of FIG. 7A. A bottom view of the furniture glide 20c is depicted in FIG. 7C.

As best understood by comparing FIG. 7B to FIGS. 7A and 7C, the donut dimples 70 have smooth and rounded circular shapes so that a relatively small surface area of each donut dimple 70 actually makes contact with a floor while the furniture glide 20f bears a load. The smooth shape of the donut dimples 70 combined with resulting reduced surface area of the floor contact surface 56f that contacts the floor substantially reduces friction to enable a piece of furniture to be easily moved when the furniture glide 20f moves across a floor. The donut dimples 70 also typically comprise a material that minimizes damage to the floor and/or minimizes noise that results when the furniture glide 20f is moved across the floor. The donut dimples 70 can be part of the single, integral assembly of the furniture glide 20f or be part of a floor contact element that is attached to the glide base 22f with either a structural or adhesive connection.

Although the invention has been shown and described as having spring fingers that are molded into a single, flexible furniture glide assembly where the fingers are biased toward the inner portion of a glide base due to the memory shape of the furniture glide material, it will be appreciated that some embodiments of the invention allow for the receipt of expansion forces and for inward and outward movement of each spring finger using other configurations. For example, FIG. 8A is a perspective view of a furniture glide 20g of the invention in which the attached end 34g of each spring finger 32g includes a pivot extension 72 extending inward into a cutaway slot 30g toward the inner portion 24g of the glide base 22g. As best understood by comparing the top view of the furniture glide 20g in FIG. 8B with the cross sectional side view of the furniture glide 20g in FIG. 8C, each spring finger 32g is pivotally mounted on the glide base 22g with a pivot 74 that extends through the pivot extension 72. An underside 76g of each pivot extension 72 is positioned to contact and remain flush with a floor when the furniture glide 20g is positioned on the floor.

Operation of the furniture glide 20g is best understood by first referring to FIGS. 8A and 8B. When a foot (not shown in FIGS. 8A-C) is moved toward the heads 38g of the spring fingers 32g, the foot contacts the angled surface 40g of each head 38g to exert an outward expansion force against the spring fingers 32g. Referring now to the side cross sectional view of FIG. 8C, the spring fingers 32g accordingly move in an outward direction, moving on the pivots 74 via the pivot extensions 72, as shown with the broken outlines 78. This creates a clearance between the heads 38g of the spring fingers 32g which is sufficient for the foot to pass below the heads 38g and move toward the foot support surface 26g of the glide base 22g.

As the foot continues to move toward the foot support surface 26g, the foot will typically be sufficiently wide to contact top sides 80 of the pivot extensions 72 of each spring finger 32g, gathering the spring fingers 32g and forcing the fingers 32g to rotate on their pivots 74 so that the distal end 36g and head 38g of each spring finger 32g moves inward toward the inner portion 24g of the glide base 22g until the foot contacts the foot support surface 26g. This positions each spring finger 32g over the foot, locking the foot to the furniture glide 20g. If the furniture glide 20g is positioned on the floor, the load of the leg attached to the foot will exert additional force against the foot support surface 26g, causing the floor contact surface 56g to contact the floor. This will force the underside 76g of each pivot extension 72 to become flush with the floor, further locking the foot to the furniture glide 20g.

FIGS. 9A-C depict a furniture glide 20h of the invention in which the inward and outward movement of each spring finger 32h is permitted through the use of a living hinge 82h. The furniture glide 20h is preferably constructed of a flexible material such as plastic or spring metal and is formed into a single, flexible furniture glide assembly. The distal ends 36h of the spring fingers 32h extend in an inward direction toward the inner portion 24h of the glide base 22h. Each living hinge 82h is formed by a thinness of the material of the furniture glide 82h between the glide base 22h and attached ends 34h of the spring fingers 32h, allowing each of the spring fingers 32h to pivot on the living hinges 82h and move in both an inward direction toward the inner portion 24h of the glide base 22h and in an outward direction away from the inner portion 24h of the glide base 22h. An underside 76h at each attached end 34h of each spring finger 32h is positioned to contact and remain flush with a floor when the furniture glide 20g is positioned on the floor.

Operation of the furniture glide 20h is best understood by comparing the perspective and cross sectional views of FIGS. 9A and 9C with the top view of FIG. 9B. When a foot (not shown in FIGS. 9A-C) is moved toward the heads 38h of the spring fingers 32h, if the distances between the heads 38h of the spring fingers 32h are not sufficient to allow the foot to pass therebetween, the foot contacts the angled surface 40h of one or more heads 38h to exert an outward expansion force against the spring fingers 32h. Referring now to the side cross sectional view of FIG. 9C, the spring fingers 32h, if contacted by the foot, move responsively in an outward direction, pivoting on the living hinges 82. This creates a clearance between the heads 38h of the spring fingers 32h sufficient for the foot to pass below the heads 38h and move toward the foot support surface 26h of the glide base 22h. As the foot contacts the foot support surface 26h, services 29h positioned on the attached ends 34h of each spring finger 32h allow for slight variations in the sizes of feet accommodated by the foot support surface 26h.

If the furniture glide 20h is positioned on a floor, the load of the leg attached to the foot exerts a force against the foot support surface 26h, causing the floor contact surface 56h to contact the floor. This forces the underside 76h of each spring finger 32h to become flush with the floor, forcing the distal ends 36h and heads 38h of the spring fingers 32h in a direction that is toward the inner portion 24h of the glide base 22h, locking the foot to the furniture glide 20h.

It will be appreciated that some embodiments of the invention can be constructed from a single stamped or molded assembly omitting cutaway slots. Spring fingers can also be constructed to occupy substantial portions of an arcuate perimeter around a glide base. For example, FIGS. 10A-C depict a glide base 20i of the invention having expanded spring fingers 32i that extend along quadrants 84 of the perimeter of the glide base 22i, each spring finger 32i being separated from two adjacent spring fingers 32i with a narrow quadrant notch 86. No cutaway slots extend through the glide base 22i. The distal end 36i of each spring finger 32i extends in an inward direction toward the inner portion 24i of the glide base 22i. The entire assembly of the furniture glide 20i is a single molded or stamped part made of a flexible material such as plastic or spring metal having a memory shape that causes the spring fingers 32i to move in an inward direction toward the inner portion 24i of the glide base 20i when a foot (not shown in FIGS. 10A-C) contacts the foot support surface 26i.

It will be further appreciated that some embodiments of the invention may incorporate a separate spring element to cause the spring fingers to move in an inward direction when a foot contacts the foot support surface of the furniture glide. For example, FIG. 11A depicts a furniture glide 20j of the invention having an expanded glide base 22j that includes back walls 88 which expand upward in a direction that is away from the foot support surface 26j. The distal end 36j of each spring finger 32j extends in an inward direction toward the inner portion 24j of the glide base 22j. Spring elements 90 extend between each spring finger 32j and one of the back walls 88, biasing the spring fingers 32j away from the back walls 88 and toward the inner portion 24j of the glide base 22j.

Referring now to the top and side cross sectional views of the furniture glide 20j in FIGS. 11B and 11C, the engagement of a foot (not shown in FIGS. 11A-C) by the furniture glide 20j is described with a comparison of one spring finger 32j′ and it's associated elements, each denoted with an element number having a prime indicator (e.g. 90′), that are depicted as if the spring finger 32j′ is receiving an expansion force from a foot that is being moved toward the foot support surface 26j. The remaining spring fingers 32j and associated elements, not having prime indicators, are depicted as if no expansion force is being received.

Each spring finger 32j includes a dovetail extension 92 or 92′, attached to the attached end 34j or 34j′ of the spring finger 32j or 32j′, which slidably connects the spring finger 32j or 32j′ to the glide base 22j via a dovetail mounting 94 or 94′. When the foot is moved towards the foot support surface 26j, the foot contacts the angled surface 40j or 40j′ of the spring finger 32j or 32j′ and exerts an outward expansion force to move the spring finger 32j or 32j′ on its dovetail mounting 94 or 94′ in an outward direction 96 against the bias of the spring elements 90 or 90′ toward the back wall 88 or 88′. In FIGS. 11B and 11C, the spring elements 90′ are depicted as being compressed after the spring finger 32j′ has itself fully moved away from the inner portion 24j of the glide base 22j and to the extent that the attached end 34j′ of the spring finger 23j′ is in contact with the back wall 88′. Once the foot passes below the head 38j′ of the spring finger 23j′, the spring finger 23j′ moves on its dovetail mounting 94j′ in an inward direction 98, under the biasing force of the spring elements 90′, toward the inner portion 24j of the glide base 22j, to lock the foot to the furniture glide 20j, as depicted by the spring fingers 34j.

The invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A furniture glide comprising:
a glide base having an inner portion and a foot support surface;
a plurality of spring fingers, each said spring finger being positioned on said glide base and having an attached end connected to said glide base, each said spring finger having a distal end extending in an inward direction toward said inner portion of said glide base, each said distal end further extending in an outward direction away from said foot support surface;
a head positioned at about said distal end of each said spring finger, each said head being positioned to receive an outward expansion force from a foot to move at least one of said spring fingers in an outward direction away from said inner portion of said glide base when the foot is moved toward said foot support surface; and
said spring fingers being positioned to move in an inward direction toward said inner portion of said glide base to engage and lock the foot to said furniture glide when the foot contacts said foot support surface.

2. The furniture glide of claim 1 wherein said spring fingers are positioned to be connected at said attached ends to said glide base about equidistantly in 90-degree increments.

3. The furniture glide of claim 1 further comprising a hole extending through said major planar dimension of said glide base, said hole having a hole diameter that is smaller than a foot diameter of the foot to prevent the foot from passing through said foot support surface.

4. The furniture glide of claim 1 wherein each of said spring fingers comprises a flexible material having a memory shape, said memory shape causing each of said spring fingers to move in an inward direction toward said inner portion of said glide base to engage and lock the foot to said furniture glide when the foot contacts said foot support surface.

5. The furniture glide of claim 1 wherein each of said spring fingers comprises a flexible, molded polymer material having a memory shape, said memory shape causing each of said spring fingers to move in an inward direction toward said inner portion of said glide base to engage and lock the foot to said furniture glide when the foot contacts said foot support surface.

6. The furniture glide of claim 1 wherein each of said spring fingers is spring biased toward said inner portion of said glide base, said spring bias causing each of said spring fingers to move in an inward direction toward said inner portion of said glide base to engage and lock the foot to said furniture glide when the foot contacts said foot support surface.

7. The furniture glide of claim 1 wherein said glide base and said spring fingers are molded into a single, flexible furniture glide assembly.

8. The furniture glide of claim 1 wherein each of said spring fingers are connected at said attached ends with hinges to said glide base and spring biased toward said inner portion of said glide base, causing said distal ends of each of said spring fingers to move in an inward direction toward said inner portion of said glide base to engage and lock the foot to said furniture glide when the foot contacts said foot support surface.

9. The furniture glide of claim 1 wherein each of said spring fingers is connected at said attached end with a living hinge to said glide base.

10. The furniture glide of claim 1 wherein each of said spring fingers is slidably positioned on said glide base and biased to an inward direction toward said inner portion of said glide base, each said finger being positioned to slidably move against its bias in an outward direction away from said inner portion of said glide base when the foot exerts an outward expansion force against said fingers.

11. The furniture glide of claim 1 further comprising a floor contact surface of said glide base that minimizes noise when said furniture glide drags against a floor while engaging the foot.

12. The furniture glide of claim 1 further comprising a floor contact surface of said glide base that minimizes damage to floor surfaces when said furniture glide drags against a floor while engaging the foot.

13. The furniture glide of claim 1 further comprising a floor contact surface of said glide base, said floor contact surface being dimpled to reduce friction against a floor when said furniture glide drags against the floor while engaging the foot.

14. The furniture glide of claim 1 wherein said glide base includes a plurality of floor contact blisters that minimize friction when said furniture glide drags against a floor while engaging the foot.

15. The furniture glide of claim 1 wherein said glide base includes a plurality of donut dimples that minimize friction when said furniture glide drags against a floor while engaging the foot.

16. The furniture glide of claim 1 further comprising a floor contact surface of said glide base, said floor contact surface including felt to reduce friction against a floor when said furniture glide drags against the floor while engaging the foot.

17. The furniture glide of claim 1 further comprising a floor contact surface of said glide base, said floor contact surface including a low friction-producing material that minimizes noise when said furniture glide drags against a floor while engaging the foot.

18. The furniture glide of claim 1 further comprising a floor contact surface of said glide base, said floor contact surface including a low-friction producing material that minimizes damage to floor surfaces when said furniture glide drags against a floor while engaging the foot.

19. The furniture glide of claim 1 further comprising a floor contact surface of said glide base, said floor contact surface including a low-friction producing material that is attached to said glide base with a dovetail fitting.

20. The furniture glide of claim 1 further comprising a floor contact surface of said glide base, said floor contact surface including a low-friction producing material that is attached to said glide base with an undercut fitting.

21. The furniture glide of claim 1 further comprising a floor contact surface of said glide base, said floor contact surface including a low-friction producing material that is mechanically attached to said glide base.

22. The furniture glide of claim 1 further comprising a floor contact surface of said glide base, said floor contact surface including a low-friction producing material that is adhesively attached to said glide base.

23. The furniture glide of claim 1 further comprising a floor contact surface of said glide base, said floor contact surface including a high-friction producing material.

24. A furniture glide comprising:
a glide base having an outer portion, an inner portion, and a foot support surface;
a plurality of spring fingers, each said spring finger being flexibly positioned on said glide base and having an attached end connected to said outer portion of said glide base, each said spring finger having a distal end extending in an inward direction toward said inner portion of said glide base, each said distal end further extending in an outward arcuate direction away from said foot support surface;
a head positioned at about said distal end of each said spring finger, each said head being positioned to receive an outward expansion force from a foot to move at least one of said spring fingers in an outward direction away from said inner portion of said glide base when the foot is moved toward said foot support surface; and
said spring fingers being positioned to move in an inward direction toward said inner portion of said glide base to engage and lock the foot to said furniture glide when the foot contacts said foot support surface.

25. The furniture glide of claim 24 wherein said foot support surface includes an indentation for receiving the foot.

26. The furniture glide of claim 24 wherein said foot support surface includes an indentation for receiving the foot, said foot support surface allowing the foot to exert shear forces against said glide base when the foot is moved across a floor.

27. The furniture glide of claim 24 wherein said spring fingers are positioned to be connected at said attached ends to said outer portion of said glide base about equidistantly in 90-degree increments around said outer portion.

28. The furniture glide of claim 24 further comprising a hole extending through said major planar dimension of said glide base, said hole having a hole diameter that is smaller than a foot diameter of the foot to prevent the foot from passing through said foot support surface.

29. The furniture glide of claim 24 wherein each of said spring fingers comprises a flexible material having a memory shape, said memory shape causing each of said spring fingers to move in an inward direction toward said inner portion of said glide base to engage and lock the foot to said furniture glide when the foot contacts said foot support surface.

30. The furniture glide of claim 24 wherein each of said spring fingers comprises a flexible, molded polymer material having a memory shape, said memory shape causing each of said spring fingers to move in an inward direction toward said inner portion of said glide base to engage and lock the foot to said furniture glide when the foot contacts said foot support surface.

31. The furniture glide of claim 24 wherein each of said spring fingers is spring biased toward said inner portion of said glide base, said spring bias causing each of said spring fingers to move in an inward direction toward said inner portion of said glide base to engage and lock the foot to said furniture glide when the foot contacts said foot support surface.

32. The furniture glide of claim 24 wherein said glide base and said spring fingers are molded into a single, flexible furniture glide assembly.

33. The furniture glide of claim 24 wherein each of said spring fingers are connected at said attached ends with hinges to said glide base and spring biased toward said inner portion of said glide base, causing said distal ends of each of said spring fingers to move in an inward direction toward said inner portion of said glide base to engage and lock said foot to said furniture glide when the foot contacts said foot support surface.

34. The furniture glide of claim 24 wherein each of said spring fingers is connected at said attached end with a living hinge to said glide base.

35. The furniture glide of claim 24 wherein each of said spring fingers is slidably positioned on said glide base and biased to an inward direction toward said inner portion of said glide base, each said finger being positioned to slidably move against its bias in an outward direction away from said inner portion of said glide base when the foot exerts an outward expansion force against said fingers.

36. The furniture glide of claim 24 further comprising a floor contact surface of said glide base that minimizes noise when said furniture glide drags against a floor while engaging the foot.

37. The furniture glide of claim 24 further comprising a floor contact surface of said glide base that minimizes damage to floor surfaces when said furniture glide drags against a floor while engaging the foot.

38. The furniture glide of claim 24 further comprising a floor contact surface of said glide base, said floor contact surface being dimpled to reduce friction against a floor when said furniture glide drags against the floor while engaging the foot.

39. The furniture glide of claim 24 wherein said glide base includes a plurality of floor contact blisters that minimize friction when said furniture glide drags against a floor while engaging the foot.

40. The furniture glide of claim 24 wherein said glide base includes a plurality of donut dimples that minimize friction when said furniture glide drags against a floor while engaging the foot.

41. The furniture glide of claim 24 further comprising a floor contact surface of said glide base, said floor contact surface including felt to reduce friction against a floor when said furniture glide drags against the floor while engaging the foot.

42. The furniture glide of claim 24 further comprising a floor contact surface of said glide base, said floor contact surface including a low friction-producing material that minimizes noise when said furniture glide drags against a floor while engaging the foot.

43. The furniture glide of claim 24 further comprising a floor contact surface of said glide base, said floor contact surface including a low-friction producing material that minimizes damage to floor surfaces when said furniture glide drags against the floor while engaging the foot.

44. The furniture glide of claim 24 further comprising a floor contact surface of said glide base, said floor contact surface including a low-friction producing material that is attached to said glide base with a dovetail fitting.

45. The furniture glide of claim 24 further comprising a floor contact surface of said glide base, said floor contact surface including a low-friction producing material that is attached to said glide base with an undercut fitting.

46. The furniture glide of claim 24 further comprising a floor contact surface of said glide base, said floor contact surface including a low-friction producing material that is mechanically attached to said glide base.

47. The furniture glide of claim 24 further comprising a floor contact surface of said glide base, said floor contact surface including a low-friction producing material that is adhesively attached to said glide base.

48. The furniture glide of claim 24 further comprising a floor contact surface of said glide base, said floor contact surface including a high-friction producing material.

49. A furniture glide comprising:
a glide base having an inner portion and a foot support surface, said foot support surface having an indentation for receiving a foot;
a plurality of spring fingers, each said spring finger being positioned on said glide base and having an attached end connected to said glide base, each said spring finger having a distal end extending in an inward direction toward said inner portion of said glide base, each said distal end further extending in an outward direction away from said foot support surface;
a head positioned at about said distal end of each said spring finger, each said head being positioned to receive an outward expansion force from the foot to move at least one of said spring fingers in an outward direction away from said inner portion of said glide base when the foot is moved toward said foot support surface;
said spring fingers being positioned to move in an inward direction toward said inner portion of said glide base to engage and lock the foot to said furniture glide when the foot contacts said foot support surface, said foot support surface allowing the foot to exert shear forces against said glide base when the foot is moved across a floor.

50. The furniture glide of claim 49 wherein said spring fingers are positioned to be connected at said attached ends to said glide base about equidistantly in 90-degree increments.

51. The furniture glide of claim 49 further comprising a hole extending through said major planar dimension of said glide base, said hole having a hole diameter that is smaller than a foot diameter of the foot to prevent the foot from passing through said foot support surface.

52. The furniture glide of claim 49 wherein each of said spring fingers comprises a flexible material having a memory shape, said memory shape causing each of said spring fingers to move in an inward direction toward said inner portion of said glide base to engage and lock the foot to said furniture glide when the foot contacts said foot support surface.

53. The furniture glide of claim 49 wherein each of said spring fingers comprises a flexible, molded polymer material having a memory shape, said memory shape causing each of said spring fingers to move in an inward direction toward said inner portion of said glide base to engage and lock the foot to said furniture glide when the foot contacts said foot support surface.

54. The furniture glide of claim 49 wherein each of said spring fingers is spring biased toward said inner portion of said glide base, said spring bias causing each of said spring fingers to move in an inward direction toward said inner portion of said glide base to engage and lock the foot to said furniture glide when the foot contacts said foot support surface.

55. The furniture glide of claim 49 wherein said glide base and said spring fingers are molded into a single, flexible furniture glide assembly.

56. The furniture glide of claim 49 wherein each of said spring fingers are connected at said attached ends with hinges to said glide base and spring biased toward said inner portion of said glide base, causing said distal ends of each of said spring fingers to move in an inward direction toward said inner portion of said glide base to engage and lock the foot to said furniture glide when the foot contacts said foot support surface.

57. The furniture glide of claim 49 wherein each of said spring fingers is connected at said attached end with a living hinge to said glide base.

58. The furniture glide of claim 49 wherein each of said spring fingers is slidably positioned on said glide base and biased to an inward direction toward said inner portion of said glide base, each said finger being positioned to slidably move against its bias in an outward direction away from said inner portion of said glide base when the foot exerts an outward expansion force against said fingers.

59. The furniture glide of claim 49 further comprising a floor contact surface of said glide base that minimizes noise when said furniture glide drags against a floor while engaging the foot.

60. The furniture glide of claim 49 further comprising a floor contact surface of said glide base that minimizes damage to floor surfaces when said furniture glide drags against a floor while engaging the foot.

61. The furniture glide of claim 49 further comprising a floor contact surface of said glide base, said floor contact surface being dimpled to reduce friction against a floor when said furniture glide drags against the floor while engaging the foot.

62. The furniture glide of claim 49 wherein said glide base includes a plurality of floor contact blisters that minimize friction when said furniture glide drags against a floor while engaging the foot.

63. The furniture glide of claim 49 wherein said glide base includes a plurality of donut dimples that minimize friction when said furniture glide drags against a floor while engaging the foot.

64. The furniture glide of claim 49 further comprising a floor contact surface of said glide base, said floor contact surface including felt to reduce friction against a floor when said furniture glide drags against the floor while engaging the foot.

65. The furniture glide of claim 49 further comprising a floor contact surface of said glide base, said floor contact surface including a low friction-producing material that minimizes noise when said furniture glide drags against a floor while engaging the foot.

66. The furniture glide of claim 49 further comprising a floor contact surface of said glide base, said floor contact surface including a low-friction producing material that minimizes damage to floor surfaces when said furniture glide drags against a floor while engaging the foot.

67. The furniture glide of claim 49 further comprising a floor contact surface of said glide base, said floor contact surface including a low-friction producing material that is attached to said glide base with a dovetail fitting.

68. The furniture glide of claim 49 further comprising a floor contact surface of said glide base, said floor contact surface including a low-friction producing material that is attached to said glide base with an undercut fitting.

69. The furniture glide of claim 49 further comprising a floor contact surface of said glide base, said floor contact surface including a low-friction producing material that is mechanically attached to said glide base.

70. The furniture glide of claim 49 further comprising a floor contact surface of said glide base, said floor contact surface including a low-friction producing material that is adhesively attached to said glide base.

71. The furniture glide of claim 49 further comprising a floor contact surface of said glide base, said floor contact surface including a high-friction producing material.

72. A furniture glide cap comprising:
a glide base having an outer portion, an inner portion, and a foot support surface;
a plurality of spring fingers, each said spring finger being flexibly positioned on said glide base and having an attached end connected to said outer portion of said glide base, each said spring finger having a distal end extending in an inward direction toward said inner portion of said glide base, each said distal end further extending in an outward arcuate direction away from said foot support surface, each of said spring fingers comprises a flexible molded material having a memory shape, said spring fingers being positioned about equidistantly in 90-degree increments around said outer portion;
an indentation positioned on said foot support surface for receiving said foot;
a head positioned at about said distal end of each said spring finger, each said head being positioned to receive an outward expansion force from a foot to move at least one of said spring fingers in an outward direction away from said inner portion of said glide base when the foot is moved toward said foot support surface;
said memory shape causing each of said spring fingers to move in an inward direction toward said inner portion of said glide base to engage and lock the foot to said furniture glide when the foot contacts said foot support surface; and
a floor contact surface of said glide base including a low-friction producing material that minimizes noise and damage when said furniture glide drags against a floor while engaging the foot.

73. A furniture glide cap comprising:
a glide base having an outer portion, an inner portion, and a foot support surface;
a plurality of spring fingers, each said spring finger being flexibly positioned on said glide base and having an attached end connected to said outer portion of said glide base, each said spring finger having a distal end extending in an inward direction toward said inner portion of said glide base, each said distal end further extending in an outward arcuate direction away from said foot support surface, each of said spring fingers comprises a flexible molded material having a memory shape, said spring fingers being positioned about equidistantly in 90-degree increments around said outer portion;
an indentation positioned on said foot support surface for receiving a foot;
a head positioned at about said distal end of each said spring finger, each said head being positioned to receive an outward expansion force from the foot to move at least one of said spring fingers in an outward direction away from said inner portion of said glide base when the foot is moved toward said foot support surface;
said memory shape causing each of said spring fingers to move in an inward direction toward said inner portion of said glide base to engage and lock the foot to said furniture glide when the foot contacts said foot support surface, said foot support surface allowing the foot to exert shear forces against said glide base when the foot is moved across a floor; and
a floor contact surface of said glide base including a low-friction producing material that minimizes noise and damage when said furniture glide drags against the floor while engaging the foot.
